(19) United States
(12) Patent Application Publication
(10) Pub. No.: US 2005/0195901 A1
(43) Pub. Date: Sep. 8, 2005

(54) Video compression method optimized for low-power decompression platforms

(76) Inventors: Teemu Pohjola, Espoo (FI); Martti Kesaniemi, Helsinki (FI); Kalle Soukka, Helsinki (FI); Tero Myllymaki, Helsinki (FI)

Correspondence Address: SALTAMAR INNOVATIONS, 30 FERN LANE, SOUTH PORTLAND, ME, 04106, US

(21) Appl. No.: 10/792,310

(22) Filed: Mar. 3, 2004

(51) Int. Cl. H04N 7/12

(52) U.S. Cl. 375/240.24; 375/240.01

(57) ABSTRACT

An encoder is provided with an additional coding feature that comprises a time-related term added to a traditional cost function that uses only distortion and byte usage for calculating cost. The time-related term comprises the time that a real decoder needs for decoding a block, and a coefficient. The use of the time-related term will often result in a decision to select a compression mode that is faster to decode than a mode obtained with the traditional cost function. Preferably each receiving terminal belongs to a certain capacity group having specific additional coding features. A single original video is encoded individually for each capacity group according to the additional features of the capacity group in question. The individual encoding relating to each group guarantees that decoding times of frames absolutely or in average remain below the time that real receiving terminals need for decoding encoded frames.

### TECHNICAL FIELD

The present invention relates generally to video information delivery systems, and more particularly to encoders producing compressed bit streams.

### BACKGROUND ART

Mobile communications is currently one of the fastest growing markets although today the functionalities of mobile communications are rather limited. It is expected that image information, especially real-time video information, will greatly add to the value of mobile communications. Low cost mobile video transmission is highly sought after many practical applications, e.g., mobile visual communications, live TV news reports, mobile surveillance, computer games, etc. However, different from speech information, video information needs greater bandwidth and processing performance. The available bandwidth is one of the major limitations to real-time mobile video transmission and therefore such a transmission can only be achieved when a highly efficient compression algorithm with a very low implementation complexity can be implemented. In addition, the size of a display, i.e. its resolution sets limits to resolution of the compressed image. Typical sizes of compressed images are 176*144, 128*96, and 352*288 pixels.

FIG. 1 depicts main elements in video transmission. Video, which may be a film of a video clip, is retrieved form video source 1 to be compressed in encoder 2. The video is compressed and encoded into a bit stream for transmission through a transmission channel. Frame rate from the video source and frame rate of the encoded video are very often different. At the receiving terminal the bit stream received from the transmission channel is decoded in decoder 3 and finally the frames are displayed in the proper rate.

To compress motion pictures, a simple solution is to compress the picture on a frame by frame basis, for example, by means of the JPEG algorithm. Complexity of this compression is low but bit rate is rather high. Thus, to achieve high compression efficiency, advanced video compression algorithms have been developed. Typical examples include H.263-type block-based, 3D model-based, and segmentation based coding algorithms. Although based on different coding principles, these algorithms adopt a similar coding structure where the important blocks are image analysis, image synthesis, spatial encoder/decoder and modeling.

The advanced encoding is based on the fact that temporally close video frames are often quite similar; if two consecutive frames are considered often there is little movement in the background objects. The arrays of pixels of temporally close video frames often contain the same luminance and chrominance information except that the coordinate places or pixel positions of the information in the arrays are displaced as function of time defined by motion. The motion is characterized by a motion vector.

Usually the temporal compression is limited to a part of a video frame. In transform coding an input image is divided into blocks that are of rectangular, triangular, hexagonal, or any other shape. However, in many block-size coding techniques an image is first divided into 16×16 blocks and then each of these blocks is subdivided into four 8×8 quadrants. A decision criterion is applied to see if each quadrant should be encoded independently or if they can be merged and encoded as one 16×16 block. Then, a transform coding such as DCT (Discrete Cosine Transform) or discrete wavelet transform is applied.

The inter-frame encoding operations are then performed on essentially all the blocks of the video frame. As the encoding of a video frame is performed with respect to a reference video frame, implicitly a relation is defined between the blocks of the video frames under consideration and the blocks of the reference video frame.

The points described above make an encoder quite complex with high computational load. However, the encoder can rather easily be provided with a strong computational ability. In contrast, computational abilities of decoders vary greatly and therefore advanced video algorithms are difficult to implement in low power terminals to achieve live video communication.

In summary, the advanced compression methods primarily deal with the spatial compression of images and the spatial and temporal compression of video sequences. As a common feature, these methods perform compression on a per frame basis. With these methods high compression ratios for a wide range of applications can be achieved.

Most of the modern encoders allow using several optional ways to encode a given image block, wherein while a frame is being encoded the compressions applied to the blocks may vary block by block depending on the video contents. Henceforth the optional ways to encode a block are denoted compression modes.

Solving some optimization problems dictates the choice between the alternative compression modes. For example, due to a coding error resulting from each compression mode, the coding error may be weighted against the number of bytes used by the compression mode. A well-known decision criterion to determine which compression mode should finally be applied to a certain block is the Langrarian cost function.

The Lagrangian cost function is an unconstrained cost function that helps avoiding unwieldy constrained optimization problems. It recognizes that for optimal image coding, it is important to balance both bit rate and image quality. A linear function of the mean distortion D and the number of bytes B scaled by a value lambda determine the cost C. Choosing the appropriate value for lambda is important and is determined by simulation results. Ideally, a lambda should be chosen that consistently gives a cost function decision criterion that provides the highest possible image quality at the available bit rate.

Formula (1) below gives the equations for finding the Lagrangian cost function.
C=D+λB, where (1)
D stands for distortion or the coding error expressed as the sum of squared pixelwise errors,
B is the number of bytes corresponding to the distortion D, and
λ is a Lagrangian weight parameter.

If DCT (Discrete Cosine Transform) is used for encoding, then
D=E{(d(x,y)}, where d(x,y)=||x−y||2, y=DCT coefficients, and
x=quantized DCT coefficients.
B=E{length of codeword}

To find the optimal compression mode for a block, the per pixel cost functions for different compression modes are compared.

However, the available bandwidth of a transmission network limits free choosing of compression modes. A wired computer network such as the Internet offers high bit rates whereas most mobile networks allow the use of rather low bit rates. Thus, the optimal compression mode may produce an encoder output bit rate that exceeds the available bandwidth of the transmission network. Therefore, a compression mode having lower output bit rate has to be chosen.

In addition, the range of mobile terminals that are being used in different mobile networks also put limitations to the encoding methods. Retaining good visual quality of compressed videos is just one of the many requirements facing any practical video compression technology. Apart from a possible initial buffering of frames in the memory of a mobile terminal, the viewing of a video occurs in real time demanding real time decoding and playback of the video. However, the software and hardware of the mobile terminals, in other words various platforms from PDA's to mobile phones, have different capabilities concerning memory usage and processing power. This fact should be taken into account when encoding video.

Next, an encoding constraint caused by limited processing power of a decoding terminal will be discussed in more detail.

Decoding time per frame of duration T depends on ratio of the computational complexity of the encoded frame on one hand, and the processing power available on the other hand. The computational complexity reflects both the richness of details in an image and the rate at which things change from frame to frame. In the simplest case, each coded frame refers to the previous frame and the omission or loosing of any single frame would disrupt viewing of the rest of the video.

Therefore, the decoder must have sufficient time to decode a frame prior to decoding the next frame. Thus, in order to play a video at its proper frame rate the decoding time Tdec has to be shorter than the time interval Tdist between coded frames in the original video sequence. In other words, if Tdec<Tdist, then the decoder has time to idle between frames. But if Tdec>Tdist, then the decoding takes such long time that playing speed of the video will be slower than that of the original one. This is intolerable in particular if there is an audio track associated with the video. In consequence, a problem relating to decoding of video files is how to guarantee that decoders of mobile terminals having various capabilities have sufficient time to decode frames of an encoded video, and at the same time maintaining the original playing speed of the video.

One prior-art solution to the problem is to encode a video file to be playable with the low-power devices having long decoding times Tdec. Unfortunately, this option necessarily deteriorates the quality of the video played in more powerful devices having short decoding times. A drawback is also underutilization of the available bandwidth and, pertaining to powerful devices, the processor resources.

Another prior-art solution is to encode one file for each different platform by using a format that allows the decoder to utilize as much of the received data as possible. Higher level of details typically requires more from the decoder than a fuzzier version of the same image. Such a scalable video format can be achieved in two ways. Either some entire frames may be dropped or the frames can be decoded and displayed at different levels of detail. A drawback of this option is that it clearly wastes a part of the bandwidth if some data is not used.

Still another prior-art solution is to encode same video file in different manners so that a few different files are produced, each with a different level of complexity. The files are, for example, named such that the target platforms know which of the files best suits its resources. This option has the drawback that the codecs (CODer-DECoder) are designed to trade off quality (combination of image quality and frame rate) for saving the bandwidth; typically the decoding time depends monotonically on the number of bytes used in coding.

FIGS. 2A and 2B illustrate the performance of four alternative coding modes applied to a hypothetical image block. The term “mode” refers to different compression methods and also variations of the same method, wherein varying parameters of algorithms forms variations of the method.

In FIG. 2A each coding mode has its own complexity; mode• 1 is simple whereas mode 4 is complex. Coding mode 1 produces a low encoder output bit rate, wherein the decoding time of a frame is short. Mode 2 when applied in the encoder produces a slightly higher encoder output bit rate, which increases the decoding time of a frame. Consequently, encoder output bit rate of mode 4 is rather high which means high decoding time in a receiver. Thus, the higher the encoder output bit rate is the longer is the time the receiver needs for decoding a frame.

But on the other hand, the higher the encoder output bit rate, the better the quality of decoded frames. As depicted in FIG. 2B, mode 1 that requires only a low bandwidth yields low quality video whereas complex mode 4 requires high bandwidth but offers good video quality. According to available methods the only way to achieve low complexity is to decrease quality and thereby also the bandwidth. If the network connection remains the same, the lower-end phones will end up using only a part of the already small bandwidth.

### SUMMARY OF THE INVENTION

A common drawback of the prior art compression methods is the omission of decoding times that decoders of various platforms need for decoding frames. This is because cost functions are calculated in codecs using distortion i.e. coding error and byte usage only. Therefore, the prior-art codecs fail to encode a video so that the best possible quality is achieved while at the same time utilizing in the full extent the available bandwidth of the transmission channel and CPU power of receiving terminals.

One objective of the present invention is to provide an encoding method that takes into account decoding capacity of a decoder while comparing a cost function of different compression modes in order to find the optimal mode to compress a block.

The objective is achieved by first acquiring detailed knowledge of the decoding capacity of various platforms. In other words, decoding times of frames or blocks encoded with various modes are sought. Testing a major part of the mobile terminal brands on the market can do this. After enough knowledge has been gathered, capacity groups are advantageously formed from the platforms having almost the same decoding capacity. Thus, each mobile terminal belongs to a certain capacity group depending on its processing power and software.

Then, an encoder is provided with an additional coding feature for controlling the encoding process. Each capacity group has its own additional coding features. Next, the same original video is encoded individually for each capacity group according to the additional features of the capacity group in question. The individual encoding relating to each group guarantees that average or absolute decoding times of frames remain below the time that a decoder of a mobile terminal in a group needs for decoding a frame received from a transmission channel. After the video has been encoded in different ways, the encoded videos are stored in a video storage.

Now, after a video server has received a request for a video from a mobile terminal belonging to a certain capacity group, the video encoded particularly for that capacity group is fetched from the video storage and transmitted further to the mobile terminal.

Alternatively, instead of storing encoded videos beforehand, not until in receipt of the request the video server determines the capacity group based on information included in the request. Then the server encodes the video and transmits it to the mobile terminal. Hence, determination of the capacity group and encoding of the video is performed “on the fly”.

In the preferred embodiment, the additional coding feature comprises a time-related term added to a traditional cost function. Said time-related term comprises the time that a decoder needs for decoding a block, and a coefficient. The use of the time-related term as a part of the cost function will often result in a decision to select a compression mode that is faster to decode than a mode obtained with the traditional cost function. Although the selected compression mode may result in higher distortion or a higher amount of bytes per block than any of the modes obtained with the use of the traditional cost function, the decoding process is fast and the total viewing experience is improved. It is worth noting that despite a faster encoding mode obtained with the additional coding feature the decrease of quality in terms of distortion and byte usage is rather small in comparison to the quality achieved with the traditional cost function. In consequence, when a cost function is applied for deciding upon the optimal coding of a block, also the decoding capacity of the receiving terminal is taken into account.

Preferably the traditional cost function is the Lagrangian cost function.

Optionally, the invention may be further enhanced by considering additional decoding modes (extra modes) that are within the capabilities of the decoder. Contrary to the traditional compressing modes that are optimized solely for distortion and bandwidth, the extra modes are optimized for distortion and decoding times. Therefore, when the cost function comprising the time-related term is used for the modes the probability increases that an extra mode is selected as the final compression mode. In other words, the use of an extra mode for compression may resuit in rather high distortion but the time needed for decompression is short and always within the capabilities of the decoder. This has beneficial effect on the viewing experience.

The proposed method and encoder are applicable for video servers.

### DESCRIPTION OF THE DRAWINGS

In the drawings

FIG. 1 depicts generally transmission of a video FIGS. 2A and 2B illustrates of compression modes,

FIG. 3 is a flowchart of achieving data of terminals,

FIG. 4 is a flowchart of selecting compression mode

FIG. 5 illustrates effect of a traditional cost function

FIG. 6 depicts effect of the extended cost function,

FIG. 7 is an example of the extended cost function,

FIGS. 8A and 8B are another example of the extended cost function,

FIG. 9 illustrates adding of extra modes, and

FIG. 10 depicts a video server.

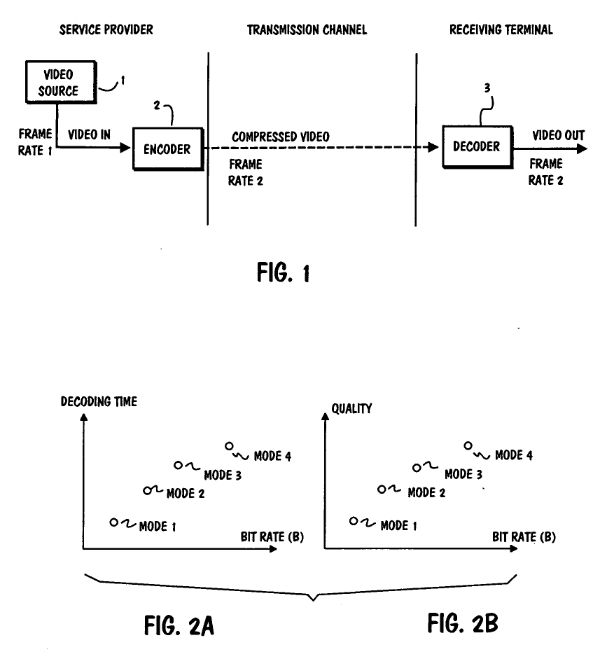

### DETAILED DESCRIPTION

Assuming each coded frame refers to the previous frame, i.e. for decoding a frame, information received in the previous frame is needed, omission of a frame in a receiving terminal may be fatal for decoding a video from that frame onwards. Therefore, time interval T_{dist} between two coded frames in the original video sequence should be longer than the time Tₙ that a decoder needs for decoding a frame. However, a video service provider usually lacks knowledge of the required decoding times Tₙ. Further, time Tₙ is decoder-specific due to various processing powers of receiving terminals.

Considering video encoding, the inventors have noted that two decoder-relating factors should preferably be taken into account; namely time Tₙ needed to decode a frame and the amount of bytes B of the frame. Both factors depend on the compression modes of the blocks of the frame. However, today video-service providers have neither any knowledge of operating systems nor decoding times of various receiving terminals. That's why they offer a single encoded video file with constant quality, frame rate, etc.

The preferred embodiment of the invention considers capability of a receiving terminal by defining the decoding time Tₙ of a frame n as follows:

$${T}_{n} = {T}^{fixed} + {\sum }_{i = 1}^{N} {T}_{n}^{i}$$

where T^{fixed} is the decoding time of a fixed overhead, and
Tₙⁱ is decoding time of block i of frame n.

The fixed decoding-time overhead includes the handling of the video stream or file, decoding of any entropy coding, looping through the image blocks, post-processing of an image and displaying the resulting image.

Further, the byte usage for the frame n comprises bytes B^{fixed} of fixed overhead including e.g. a header and bytes of individual blocks i. Then, the byte usage for the whole frame is defined as follows:

$${B}_{n} = {B}^{fixed} + {\sum }_{i = 1}^{N} {B}_{n}^{i} ,$$

In consequence, the decoding speed of the frame is Bₙ/Tₙ.

It can be concluded from the formulas that the decoding time of a frame depends directly on the decoding time of each of the blocks. Furthermore, the block decoding time and the block byte count, both depend on the compression mode used for said block. From the decoder's point of view, the decoding time of a frame depends on the ratio of the computational complexity of the coded frame and the available processing power.

Now, for obtaining knowledge of decoding times Tₙ, information about processing power of various terminals on the market is gathered.

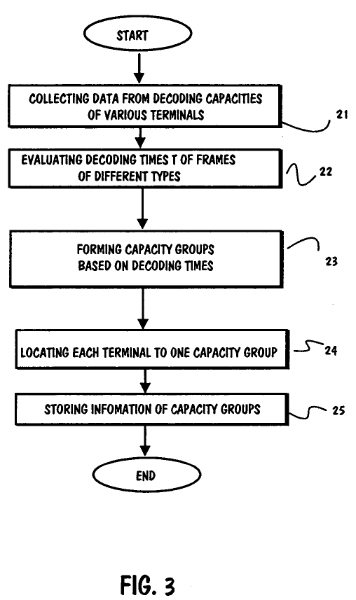

FIG. 3 shows a flowchart of various steps of gathering information. First, data from decoding capacities of various terminals is collected; step 21. There are several terminal brands on the market and several different models within a brand. But it is not necessary to collect detailed information about each brand and each model. Instead, data sheets issued by the manufacturers may be utilized. Based on the data sheets decoding times of blocks encoded with different ways may be estimated; step 22.

Optionally, some terminals may even be tested in a laboratory, wherein reference blocks encoded with different ways are input to the tested terminals and decoding times Tⁱ of the blocks are measured. The decoding time Tⁱ of each coded block may be stored but preferably the average decoding time of the blocks is stored for the desired encoding modes.

After sufficient data regarding decoding capacities of terminals has been gathered, i.e. the decoding times of encoded blocks are evaluated, the terminals are divided to capacity groups, each group comprising of terminals having similar decoding times; step 23. Because not all terminals on the market are tested, the rest of the terminals on the market are attached to the decoding groups based on their data sheets, for example, whereupon each group comprises of terminals having similar processing capacity in terms of decoding parameters; step 24. The number of capacity groups is preferably limited to be only a few, 4-6 for example. Alternatively, the manufacturers themselves may classify the terminals they manufacture into one of the selected groups, according to published criteria.

Finally, information about decoding groups, i.e. terminals and their decoding times, is stored; step 25.

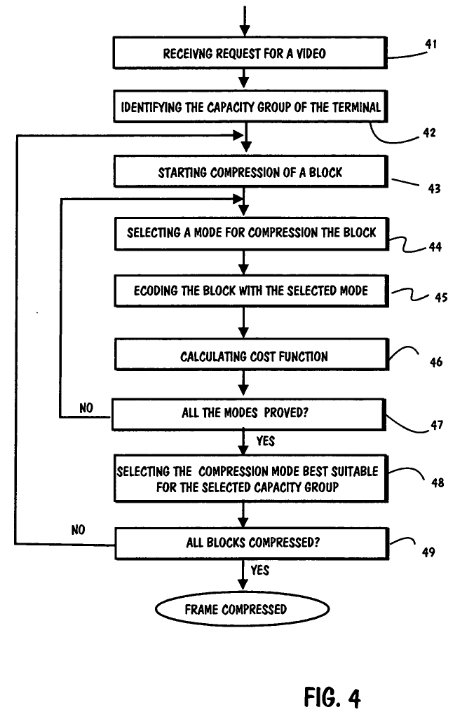

FIG. 4 depicts steps of encoding a video file at a service provider's server in accordance with the preferred embodiment of the invention. A terminal, a mobile terminal for example, sends via a transmission channel a request for a video. In receipt of the request, step 41, the server identifies the capacity group to which the terminal belongs: step 42. The server may conclude the capacity group from some parameter value in the request or it may send the terminal an inquiry about the terminal's type.

After the server has identified the capacity group of the terminal, the times the terminal needs for decoding blocks are checked. Data about the decoding times for the capacity groups may be stored in a database or, alternatively, hard coded in the encoder. Preferably, the data base returns a reply that contains a string of time values, each value Tₙⁱ telling the time that the decoder of the terminal in question needs for decoding a certain type n of a block. Alternatively, only one time value Tₙ is returned which tells the maximum time or the average time the decoder needs for decoding a block.

The server then encodes the video frames for transmission. Encoding of frames is carried out block by block. For each block to be compressed, step 43, the encoder selects a compression mode, step 41, and encodes the block with the selected mode, step 45.

Thereafter, the cost value of the encoded block is calculated; step 46. The cost value is calculated with an extended cost function that is formed from any traditional cost function plus a time-related term added into a traditional cost function. Said time-related term considers the time T that the terminal needs for decoding the block, and coefficient μ. If the Langrangian cost function D+λB is used as the traditional one, the extended cost function is as follows:
C=D+λ·B+μTⁱ,
where Tⁱ is the decoding time of the block packed into the B bytes,
the weight μ sanctions the coding choice from incurring excessive decoding time requirements.

In the traditional term (D+λ*B) of the cost function, A is used to emphasize bandwidth limitations over image quality, whereas the extension term (μ*Tⁱ) tends to emphasize a compression format that is faster to decode. Increase of the value of μ increases probability to choose a faster compression format.

After the cost value C has been calculated and stored in a memory, the block is compressed again using another compression mode. Hence, the steps 44-47 are repeated until all available modes are applied to the block. It is worth noting that when calculating the extended cost function of a mode the decoding time Tⁱ may be either the same or mode-dependent. Which is used depends on design preferences, on the specific data relating to the terminal capabilities, or other considerations at hand.

After the block has been compressed with each mode and the cost value C has been calculated for each mode, the compression mode that gives the lowest cost function will be chosen as the final compression mode; step 48.

Due to the time-related term Tⁱ such a mode will be selected which guarantees that the decoder has enough time to decode the block. Without the time-related term such guarantee is next to impossible.

Now, it is checked whether all blocks have been compressed, phase 49. If not then the next block is processed in accordance with the steps 44-48. If yes the whole frame has been compressed. Because the cost function that is applied to each block is the extended cost function having the time-related extension part, decompression times of the blocks are the same or shorter than the decoder needs. Therefore, the decoding time of the frame is also the same or shorter than the decoder needs to decode the frame prior to arrival of the next frame.

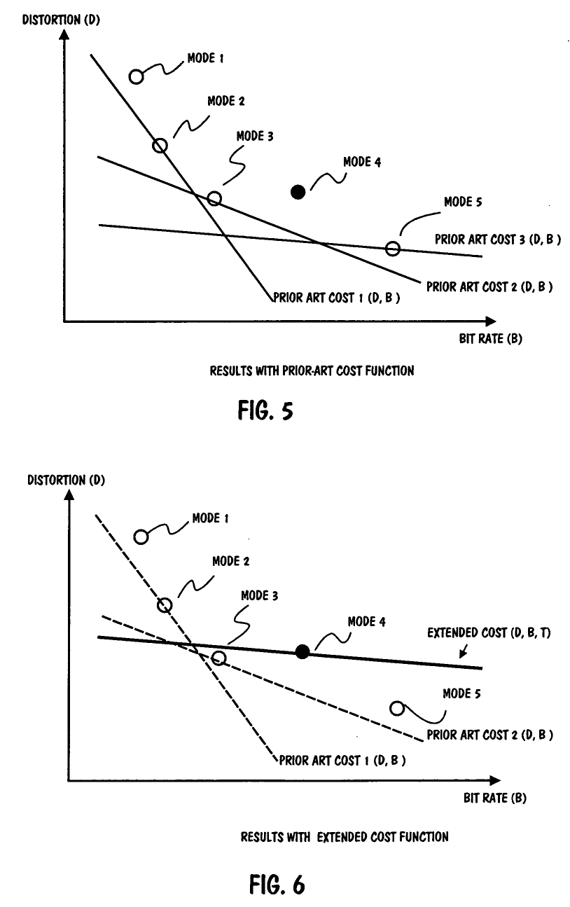

FIGS. 5 and 6 depict traditional and extended cost functions on the compression mode selection.

FIG. 5 illustrates mode selection results when a traditional cost function is used. It is an example of the performance of five modes, Mode 1-Mode 5, when these are applied to the same image block. The lines denoted as prior art cost 1 (B, D), prior art cost 2 (B, D), and prior art cost 3 (B, D) refer to Langrangian cost function (that uses only distortion D and byte usage B) with three different values λ₁, λ₂, and λ₃ of the Lagrange multiplier. Note that cost is always reduced when moving down and to the left. It is evident that Mode 4 would never be chosen for this block no matter what value λ has. However, it might be that Mode 4 is considerably faster to decode than Mode 3 or Mode 5. From the decoder's point of view this means that the decoder were able to decode the block compressed with Mode 4 but not able to decode in due time the block compressed either with Mode 3 or Mode 5, or alternatively that using MODE 4 would have offered higher frame rate within the available bandwidth.

FIG. 6 illustrates mode selection results when the extended cost function is used. Again, the same modes Mode 1-Mode 5 as in FIG. 4 are applied to the same image block. By taking into account the time-related term T and the weighting factor μ in calculating the extended cost (D, B, T), Mode 4 will now be preferred over Mode 3 and Mode 5 provided that the weighting factor μ is sufficiently biased. Although this choice provides higher distortion, i.e. lower quality, than Mode 5 and uses more bytes than Mode 3, decoding of the block is fast and the total viewing quality is better than with Mode 1 or 2.

A complete illustration of the cost function that includes the decoding times according to the invention would preferably involve a 3D plot or simultaneous analysis of two or three 2D projections. However, FIGS. 5 and 6 can also be viewed in T-B plane.

FIG. 7 illustrates mode performances in terms of byte usage in T-B plane where byte usage B is on the x-axis and decoding times T are on the Y-axis. Because the traditional cost function does not use decoding time at all it only orders Modes 1-5 according to their B values. Therefore, vertical lines represent cost functions when a traditional cost function (Cost (B, D) is used. It is evident that it is next to impossible to select the mode that gives best performance in terms of quality, efficient use of bandwidth and decoding time.

But when the extended cost function is applied then the decoding time of a decoder will be taken into account. The sloped line Cost (D, B, T) is an example of the extended cost function that leads to selection of Mode 4. Modes 1 and 2 are faster but Mode 4 offers better quality and is still fast enough to decode.

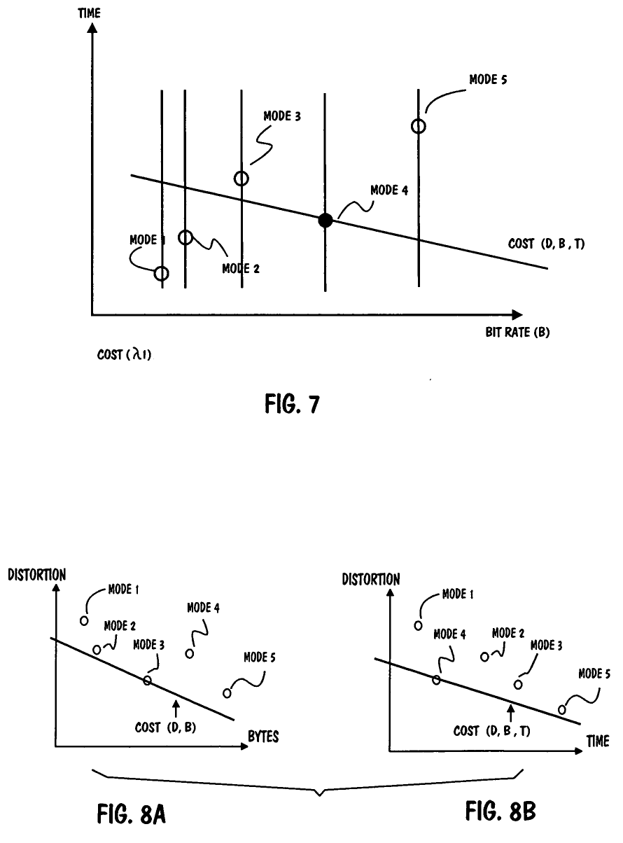

FIGS. 8A and 8B are another example of the mode selection. FIG. 8A illustrates the mode selection according to a traditional rate-distortion-based cost. Five modes are presented. If the traditional cost function is used, the quality parameter λ determines steepness of the decision line Cost (B, D). The decision line is equal to the minimum cost. As seen, the use of the traditional cost function would result in the selection of Mode 3.

FIG. 8B depicts the mode selection according to a cost function comprising only time-related factor μT. The same five modes have the same distortions as in FIG. 8A but they are now distinguished also according to their respective decoding times T. The decoding speed parameter μ adjusts the steepness of the decision curve Cost (B, D, T). As seen, the use of the pure time-related cost function would result in selection of Mode 4.

However, because the extended cost function is a combination of Cost (B, D) and Cost (T), the final mode is selected according to the combined cost function C=D+λ·B+μ·T.

Cost functions of the prior-art encoders are optimized for the distortion and the bandwidth. Accordingly, the modes in a prior-art encoder are chosen such that they are optimized for distortion and bandwidth. Therefore, use of the extended cost function does not always lead to selection of the best possible mode. Therefore, extra modes may be incorporated into a set of an encoder's existing traditional modes. The extra modes break the monotonous constellation of the traditional modes.

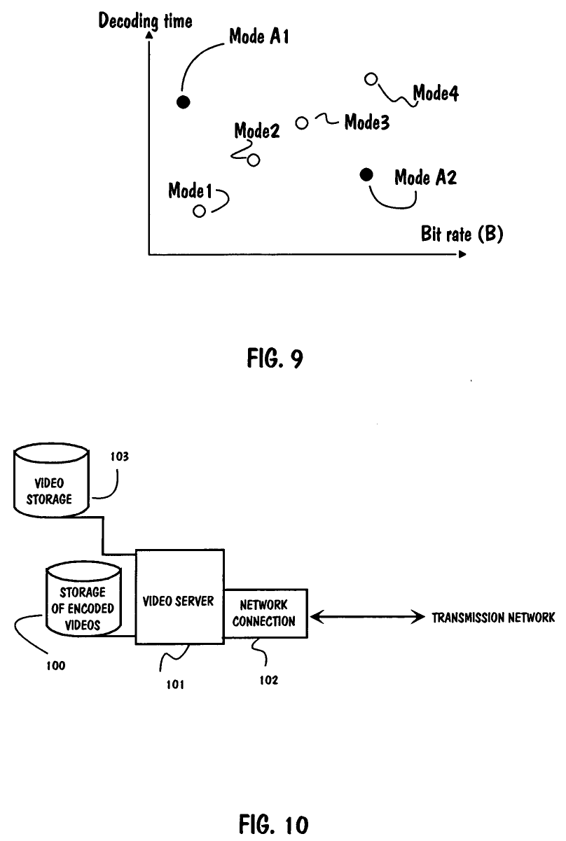

FIG. 9 illustrates performances of six modes, of which the modes 1-4 are traditional modes optimized for distortion and bandwidth. Mode 1 could correspond, for example, to simple motion estimation, and Modes 2-4 to Direct Cosine Transformation (DCT) with varying numbers of coefficients. Now, extra modes A1 and A2 are added to the set of “old” modes 1-4. The extra modes are optimized for distortion and decoding times. Unless a traditional cost function is expanded with a new term μT to form an expanded cost function, none of the extra modes would have been selected for compressing a block. Thus, the new term μT forces the cost function to take into consideration also decoding times of a receiving terminal.

Extra mode A1, for example, needs just a few bytes but apparently plenty of computation. This could be a complicated combination of neighbouring blocks indicated with a code index of a few bits. Extra mode A2, on the other hand, could be a multiple-stage VQ mode where the only computations are additions of vectors instead of function transforms. With the in-depth knowledge of what each individual decision at the encoding end means in terms of decoding time, and having knowledge of decoding times of various receiving terminals, the extended cost function and the new modes make it possible to choose a compression mode that, although may result in lower quality or a higher amount of bytes per block than any of the modes obtained with the use of the traditional cost function, is fast to decode, and hopefully provide a better image quality or frame rate utilizing the same frame rate, or otherwise beneficially effects the video viewing experience.

FIG. 10 illustrates a video server. The video server 101 includes a network unit 102 for receiving a request for a video and for transmitting encoded video frames in response to the request. The video in its original format is stored in video storage 103, or is possibly streamed to the server. The server comprises an encoder that may encode the requested video on the fly using a time-related term as described previously. The capacity group for a terminal may be derived from messages that the terminal and the video server send each other prior to the actual video request. For example, the video server may send a test message, wherein the capability of the terminal is derived from the reply message.

The video server may also encode beforehand a video with different time-related terms and store the encoded videos in video storage 100 of encoded videos. Then the version of the requested video appropriate to the terminal capacity group is delivered directly from the video storage, wherein the response time is very fast.

The proposed method can be combined at any degree with the known encoders based on the fps (frame per second) and/or image quality scaling. The method can be used in interactive services such as video telephony to achieve platform-specific streams for each party of the conversation. In the preferred usage, the method steps are embedded as a part of complete video compression/decompression software. A small decoding software package can be either pre-installed in a receiving terminal or transmitted in the beginning of the video stream.

While the present specifications have presented what is now believed to be the preferred embodiments of the invention, it is noted that the examples provided are easily extendible and modifiable in manners that will be obvious to those skilled in the art, and that the skilled person may see additional embodiments that are derived from the disclosure provided herein, and that the scope of the invention extends to such embodiments, extensions, modifications and equivalents of the inventions disclosed herein.

1. A method for choosing a compression mode from a set of compression modes, for encoding a block of a video frame, the method comprising the steps of:
compressing the block with a plurality of compression modes selected from said set, to obtain compressed blocks;
selecting a time-related term, associated with decoding time required for decoding the block by a receiving terminal;
using the time-related term as a part of an extended cost function;
calculating a cost of each of said compressed blocks;
choosing the compression mode providing a minimum cost as the final compression mode of the block.

2. The method for choosing a compression mode as in claim 1, wherein a single time-related term is used for all frames of the video.

3. The method for choosing a compression mode as in claim 2, wherein the time-related term is derived using one of a plurality of capacity groups, each capacity group comprising data of particular decoding time common to mobile terminals having approximately or precisely similar decoding capacities.

4. The method for choosing a compression mode as in claim 1, wherein a weighting factor is included in the time-related term.

5. The method for choosing a compression mode as in claim 1, wherein the extended cost function further comprise a distortion-related term and a byte usage-related term.

6. The method for choosing a compression mode as in claim 1, further comprising the step of:
using a Langrangian cost function as a part of the extended cost function.

7. The method for choosing a compression mode as in claim 1, further comprising the step of:
adding extra modes to the set of compression modes, the extra modes being optimized for various decoding times.

8. The method for choosing a compression mode as in claim 1, wherein selection of the time-related term is made in response to information about the receiving terminal capabilities.

9. The method for choosing a compression mode as in claim 8, further comprising the step of:
sending a test message to the receiving terminal; and
deriving said information from the reply to the test message;

10. The method for choosing a compression mode as in claim 2, wherein in response to a request from the receiving terminal,
a capacity group associated with the receiving terminal is selected, and,
the video encoded according to the capacity group is fetched from a video storage and transmitted to the receiving terminal.

11. The method for choosing compression mode as in claim 1, further comprising the step of receiving information regarding decoding times from the receiving terminal, and using said information in formulating the time related term.

12. An encoder for encoding a video frame divided into a plurality of blocks, and being able to encode said blocks in a plurality of compression modes, the encoder comprising:
a compression unit for compressing a block in a plurality of compression modes;
logic for calculating a cost of each compressed block utilizing an extended cost function comprising at least a time-related term selected in accordance with capabilities of an intended receiving terminal;
selection logic for selecting a compression mode having a minimum cost.

13. The encoder as in claim 12, wherein the extended cost function further comprises a distortion-related term, and a byte usage-related term.

14. The encoder as in claim 12, wherein said time related term further comprises a weighting factor.

15. An encoder according to claim 12, wherein said time related term is created in accordance with the time required to decode a block in said terminal.

16. An encoder according to claim 12, wherein the time related term is obtained from a capacity group, said capacity group being selected from a plurality of capacity groups in accordance with the type or capabilities of the receiving terminal.

17. A video server having a network unit for receiving a request for a video and for transmitting encoded video frames in response to the request, the video server comprising:
an encoder adapted to encode the video by:
selecting a time-related term corresponding to the decoding capacity of an intended receiving terminal, said time-related term reflective of decoding time required by the terminal to decode a block of an encoded video frame comprising a plurality of frame blocks;
compressing at least one of the frame blocks utilizing a plurality of compression modes to obtain a plurality of compressed blocks;
calculating a cost for at least two of said compressed blocks, utilizing an extended cost function, said function comprising a distortion-related term, a byte usage-related term, and the time-related term;
selecting the compression mode associated with the compressed block having the lowest cost, as the compression mode for encoding the relevant frame block.

18. The video server as in claim 17, wherein the server is further adapted to encode the video with different time-related terms and store the encoded videos in a video storage, wherein the requested video is delivered from the video storage.

19. The video server as in claim 17, wherein the time-related term is selected from a pre-stored set of time-related terms.

20. The video server as in claim 17, wherein said encoder is further adapted to store the selected compressed block, or to transmit the compressed block to a receiving terminal.
